(19) United States
(12) Patent Application Publication
(10) Pub. No.: US 2003/0032421 A1
(43) Pub. Date: Feb. 13, 2003

(54) Maintenance service support host apparatus

(75) Inventors: Kazuo Izumi, Tokyo (JP); Tetsuo Kimoto, Tokyo (JP); Kazuhiro Takemoto, Tokyo (JP); Kei Yamada, Tokyo (JP); Kunio Shijo, Tokyo (JP); Tomoya Yoshida, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/197,758

(22) Filed: Jul. 18, 2002

(30) Foreign Application Priority Data
Aug. 7, 2001 (JP) 239589/2001
Aug. 7, 2001 (JP) 239613/2001

(51) Int. Cl. H04M 3/00

(52) U.S. Cl. 455/420; 455/418

(57) ABSTRACT

There is described a maintenance service supporting apparatus that is coupled to an information-communicating terminal device and a stock control host apparatus through a communication network so as to supports a maintenance service operation in respect to the information-communicating terminal device. The maintenance service supporting apparatus includes a disorder information receiving section to receive disorder information sent from the information-communicating terminal device when it enters in a certain disorder condition; a disorder information table storing section to store a disorder information table in which the disorder information are correlated with parts information for restoring the disorder condition of the information-communicating terminal device; a disorder information table reading section to readout the parts information, based on the disorder information while referring to the disorder information table; and an ordering section to receive an ordering result sent from the stock control host apparatus.

### BACKGROUND OF THE INVENTION

The present invention relates to a maintenance service support host apparatus that conducts the maintenance of an information communicating terminal device.

Systems for providing service support via the Internet are coming to be commonly used in recent years. For example, a remote diagnostic system in which, in case of a fault occurring in a remote information communicating terminal device, the identification information and fault information pertaining to this information communicating terminal device are automatically sent therefrom to a maintenance host apparatus, has been devised up to now as the service support system to which the maintenance host apparatus and remote information communicating terminal devices are connected via communications lines.

However, in such conventional service support system as described above, it has been necessary that for example, once the host apparatus of the maintenance company has received fault information and identification information from the information communicating terminal device of a user, the operator responsible for the host apparatus should perform operations such as confirming details of the received information, identifying the necessary modification parts, inquiring about the stock of these modification parts, and ordering the modification parts. Therefore, the operations of the operator have been troublesome and there has been room for improvement in terms of operating efficiency and personnel costs.

Also, since the operator responsible for the host apparatus has needed to contact the responsible serviceperson after performing the above-mentioned troublesome operations, it has taken the serviceperson a great deal of time from visiting the user site to starting the necessary corrective action, and this has made it difficult for the serviceperson to respond quickly. In addition, in spite of the fact that the fault information sent from information communicating terminal devices to the host apparatus usually relates to serious faults, until the serviceperson arrives, the user cannot know when or whether his/her information communicating terminal device will be restorable from the fault or when or whether the fault will be correctable. For these reasons, much inconvenience has been caused to the user.

Also, a system by which, as in the image forming apparatus management system disclosed in Japanese Application Patent Laid-Open Publication No. Hei 11-46268, if there arises the reason for the notification of a fault, the image forming apparatus automatically notifies this fault to central control equipment and then after an instruction has been received from the equipment, notification results on the fault are displayed on the display means of the image forming apparatus for a time up to completion of the correction of the fault, has been devised up to now.

However, in such conventional service support system as described above, whether the fault was notified of has only been displayed on the display means and the processing status of the central control equipment with respect to the notification has not been reported to the user. Therefore, unless the user inquires of a service representative by telephone, when or whether the faulty information communicating terminal device will be restorable from the fault or when or whether the fault will be correctable is not notified of to the user, and this is very inconvenient to the user and is also likely to give a sense of unease to him/her in the event of a serious fault.

### SUMMARY OF THE INVENTION

To overcome the abovementioned drawbacks in conventional maintenance-service supporting systems, it is an object of the present invention to provide a maintenance-service supporting system, which makes it possible to eliminate troublesome operations from the operator of the host apparatus, to simplify modification part ordering, to achieve the improvement of maintenance efficiency and the reduction of maintenance costs, to provide the user with the latest maintenance status of his/her information communicating terminal device, and to always maintain the information communicating terminal device in its best condition.

Further, another object of the present invention is to provide any previously designated contact person with the latest maintenance information relating to the corresponding information communicating terminal device and supply highly convenient maintenance services.

Accordingly, to overcome the cited shortcomings, the abovementioned objects of the present invention can be attained by maintenance service supporting apparatus described as follow.

(1) An apparatus, coupled to an information-communicating terminal device and a stock control host apparatus through a communication network, for supporting a maintenance service operation in respect to the information-communicating terminal device, the apparatus comprising: a disorder information receiving section to receive disorder information sent from the information-communicating terminal device when it enters in a certain disorder condition; a disorder information table storing section to store a disorder information table in which the disorder information are correlated with parts information for restoring the disorder condition of the information-communicating terminal device; a disorder information table reading section to readout the parts information, based on the disorder information while referring to the disorder information table; and an ordering section to receive an ordering result sent from the stock control host apparatus.

(2) The apparatus of item 1, further comprising: an identification information receiving section to receive identification information for identifying the information-communicating terminal device, which are transmitted therefrom; a maintenance data storing section to store maintenance data in a maintenance database in which at least information of a personnel, in charge of a maintenance for the information-communicating terminal device, are correlated with the identification information; a maintenance data reading section to readout at least the information of the personnel in charge of the maintenance for the information-communicating terminal device, based on the identification information while referring to the maintenance database; and a parts information transmitting section to transmit at least a part of the parts information to a portable remote terminal possessed by the personnel, which is specified by referring to the information of the personnel in charge of the maintenance.

(3) The apparatus of item 2, wherein, in the disorder information table, the disorder information are also correlated with a disorder content occurring in the information-communicating terminal device, and the disorder information table reading section readouts the disorder content, based on the disorder information while referring to the disorder information table; and wherein, in the maintenance database, the identification information are also correlated with customer information of the information-communicating terminal device, and the maintenance data reading section readouts the customer information, based on the identification information while referring to the maintenance database; and further comprising: a maintenance information transmitting section to transmit at least a part of the disorder content and the customer information to the portable remote terminal possessed by the personnel, which is specified by referring to the information of the personnel in charge of the maintenance.

(4) The apparatus of item 2, further comprising: a disorder processing information receiving section to receive processing information, for restoring the disorder condition of the information-communicating terminal device, which are transmitted from the portable remote terminal possessed by the personnel in charge of the maintenance; and an order information creating section to create parts-ordering information, based on the processing information for restoring the disorder condition of the information-communicating terminal device.

(5) The apparatus of item 1, further comprising: a stock information receiving section to receive stock information of maintenance parts, which are transmitted from the stock control host apparatus; and a display section to display the stock information.

(6) The apparatus of item 2, wherein the apparatus is a host computer, and the information-communicating terminal device is a copier having an information-communicating function, and the portable remote terminal is a cellular phone possessed by the personnel being a serviceperson or a salesperson of a maintenance service site; and wherein the host computer, the stock control host apparatus, the copier and the cellular phone are coupled each other through the communication network including Internet and/or telephone lines, so as to constitute a system for automatically communicating information for supporting maintenance activities of the copier between them.

(7) An apparatus, coupled to an information-communicating terminal device and a stock control host apparatus through a communication network, for supporting a maintenance service operation in respect to the information-communicating terminal device, the apparatus comprising: a disorder processing information receiving section to receive processing information, for restoring a disorder condition currently occurring in the information-communicating terminal device, which are transmitted from a portable remote terminal possessed by a personnel in charge of a maintenance for the information-communicating terminal device; a progress-status information creating section to create progress-status information, based on the processing information for restoring the disorder condition; a notifying address information memory section to store address information of a notifying destination in advance, to which the progress-status information are transmitted; a specific progress-status information memory to store specific progress-status information in advance; and a progress-status information transmitting section to transmit the progress-status information to the notifying destination, based on the address information stored in the notifying address information memory section, when the progress-status information coincide with the specific progress-status information stored in the specific progress-status information memory.

(8) The apparatus of item 7, further comprising: a disorder information receiving section to receive disorder information sent from the information-communicating terminal device when it enters in the disorder condition; a disorder information table storing section to store a disorder information table in which the disorder information are correlated with a disorder content occurring in the information-communicating terminal device; a disorder information table reading section to readout the disorder content, based on the disorder information while referring to the disorder information table; an identification information receiving section to receive identification information for identifying the information-communicating terminal device, which are transmitted therefrom; a first maintenance data storing section to store first maintenance data in a first maintenance database in which at least information of a personnel, in charge of a maintenance for the information-communicating terminal device, are correlated with the identification information; a first maintenance data reading section to readout at least the information of the personnel in charge of the maintenance for the information-communicating terminal device, based on the identification information while referring to the first maintenance database; and a disorder content transmitting section to transmit at least a part of the disorder content to the portable remote terminal possessed by the personnel, which is specified by referring to the information of the personnel in charge of the maintenance.

(9) The apparatus of item 8, further comprising: a second maintenance data storing section to store second maintenance data in a second maintenance database in which at least the information of the personnel, in charge of the maintenance for the information-communicating terminal device, and user information are correlated with the identification information; a second maintenance data reading section to readout at least a part of the information of the personnel, in charge of the maintenance for the information-communicating terminal device, and at least a part of the user information, based on the identification information while referring to the second maintenance database; a maintenance information transmitting section to transmit at least a part of the user information to the portable remote terminal possessed by the personnel, which is specified by referring to the information of the personnel in charge of the maintenance.

(10) The apparatus of item 8, wherein the apparatus is a host computer, and the information-communicating terminal device is a copier having an information-communicating function, and the portable remote terminal is a cellular phone possessed by the personnel being a serviceperson or a salesperson of a maintenance service site; and wherein the host computer, the stock control host apparatus, the copier and the cellular phone are coupled each other through the communication network including Internet and/or telephone lines, so as to constitute a system for automatically communicating information for supporting maintenance activities of the copier between them.

(11) An apparatus, coupled to an information-communicating terminal device and a stock control host apparatus through a communication network, for supporting a maintenance service operation in respect to the information-communicating terminal device, the apparatus comprising: a disorder processing information receiving section to receive processing information, for restoring a disorder condition currently occurring in the information-communicating terminal device, which are transmitted from a portable remote terminal possessed by a personnel in charge of a maintenance for the information-communicating terminal device; a progress-status information creating section to create progress-status information, based on the processing information for restoring the disorder condition; a progress-status information providing section to provide the progress-status information within the communication network; an accessing-person identifying information acquiring section to acquire accessing-person identifying information for identifying an accessing-person who accesses to the progress-status information providing section; and an information supply restricting section to restrict a supply of information to be provided for the accessing-person, based on the accessing-person identifying information.

(12) The apparatus of item 11, wherein the information supply restricting section restricts the supply of information to be provided for the accessing-person, in regard to at least a part of the progress-status information.

(13) The apparatus of item 11, a restricted content memory section to store restriction data in a restricted content database in which at least the accessing-person identifying information are correlated with restricted content of the supply of information to be provided for the accessing-person; and a restriction data reading section to readout the restricted content of the supply of information to be provided by the progress-status information providing section, based on the accessing-person identifying information while referring to the restricted content database; wherein the information supply restricting section restricts a supply of information to be provided by the progress-status information providing section, based on the restricted content.

(14) The apparatus of item 11, wherein the apparatus is a host computer, and the information-communicating terminal device is a copier having an information-communicating function, and the portable remote terminal is a cellular phone possessed by the personnel being a serviceperson or a salesperson of a maintenance service site; and wherein the host computer, the stock control host apparatus, the copier and the cellular phone are coupled each other through the communication network including Internet and/or telephone lines, so as to constitute a system for automatically communicating information for supporting maintenance activities of the copier between them.

Further, to overcome the abovementioned problems, other maintenance service support host apparatus, embodied in the present invention, will be described as follow:

(15) A maintenance service support host apparatus for connecting an information communicating terminal device and a stock control host apparatus via a communications network and supporting the maintenance services relating to said information communicating terminal device, wherein said maintenance service support host apparatus is characterized in that it has

a disorder information receiving means for receiving the disorder information from said information communicating terminal device if a disorder occurs in this terminal,

a disorder contents table memory means for memorizing a disorder contents table which links said disorder information and the modification part information corresponding to the disorder in said information communicating terminal device,

a disorder information table data readout means for accessing said disorder contents table, subject to said disorder information, and then reading out said modification part information, and

an ordering means for receiving the ordering results sent from said stock control host apparatus.

Since information exchange between the user and the maintenance company, part ordering, serviceperson schedule management, and other operations can be performed using very simple procedures, the efficiency of the operator's jobs is improved which, in turn, enables significant reduction in the time required for maintenance, and leads to reduction in personnel costs. In addition, if a fault or other problems occur in the information communicating terminal device, the serviceperson cannot only respond quickly, but also conduct maintenance operations so that the information communicating terminal device can always be operated in its best condition.

(16) The maintenance service support host apparatus set forth in Item (15) above, wherein said maintenance service support host apparatus is characterized in that it is further equipped with

an identification information receiving means for receiving information communicating terminal device identification information from said information communicating terminal device,

a maintenance data memory means for memorizing a maintenance database which links at least said information communicating terminal device identification information and the responsible maintenance person information pertaining to said information communicating terminal device,

a maintenance data readout means for accessing said maintenance database, subject to said information communicating terminal device identification information, and then reading out the responsible maintenance person information pertaining to the information communicating terminal device, and

a modification part information transmission means for transmitting at least a part of said modification part information to the portable remote terminal of the responsible maintenance person identified by accessing said responsible maintenance person information.

(17) The maintenance service support host apparatus set forth in Item (16) above, wherein said maintenance service support host apparatus is characterized in that

said disorder contents table further links said disorder information and details of the disorder which has occurred in said information communicating terminal device,

said disorder contents table data readout means makes access to said disorder contents table, based on said disorder information, and reads out said disorder contents,

said maintenance database further links said information communicating terminal device identification information and the user information of said information communicating terminal device, and

said maintenance data readout means makes access to said maintenance data, based on said information communicating terminal device identification information, and then reads out the user information of said information communicating terminal device,

and in that

a maintenance information transmission means is provided to transmit at least a part of said disorder contents and said user information to the portable remote terminal of the responsible maintenance person identified by accessing said responsible maintenance person information.

The information required for recovery of the intended information communicating terminal device from the disorder status can be immediately transmitted to the responsible maintenance person.

(18) The maintenance service support host apparatus set forth in Item (16) or (17) above, wherein said maintenance service support host apparatus is characterized in that it is further equipped with

a disorder processing information receiving means for receiving disorder processing information from the portable remote terminal of said responsible maintenance person, and

an order information creating means for creating order information on said modification parts, based on said disorder processing information.

The progress of disorder processing in the information communicating terminal device by the maintenance company can be notified of to the user. Also, inquiry of the stock control host apparatus about stock confirmation, and ordering to the host apparatus are possible.

(19) The maintenance service support host apparatus set forth in either Item (15), (16), (17), or (18) above, wherein said maintenance service support host apparatus is characterized in that it is further equipped with

a stock information receiving means for receiving the stock information on said modification parts that is transmitted from said stock host apparatus, and

a display means for displaying said stock information.

The latest stock control information can always be acquired and displayed.

(20) A maintenance service support host apparatus for connecting an information communicating terminal device and a stock control host apparatus via a communications network and supporting the maintenance services relating to said information communicating terminal device, wherein said maintenance service support host apparatus is characterized in that it has

a disorder processing information receiving means for receiving the disorder processing information sent from the portable remote terminal of the responsible maintenance person for said information communicating terminal device,

a progress-status information creating means for creating progress-status information based on said disorder processing information,

a notification destination information memory means into which the notification destination information relating to said progress-status information has been stored beforehand, a specific progress-status information memory means into which specific progress-status information has been stored beforehand, and

a progress-status information transmission means by which, when said progress-status information is the progress-status information that has been stored into said specific progress-status information memory means, the corresponding progress-status information is transmitted to the notification destination that has been stored into said notification destination information memory means.

(21) The maintenance service support host apparatus set forth in Item (20) above, wherein said maintenance service support host apparatus is characterized in that it is further equipped with

a disorder information receiving means for receiving the disorder information sent from said information communicating terminal device if a disorder occurs in this terminal,

a disorder contents table memory means for memorizing a disorder contents table which links said disorder information and details of the disorder which has occurred in said information communicating terminal device,

a disorder contents table data readout means for accessing said disorder contents table, subject to said disorder information, and reading out said disorder contents,

an identification information receiving means for receiving the information communicating terminal device identification information sent from said information communicating terminal device,

a first maintenance data memory means for memorizing a first maintenance database which links at least said information communicating terminal device identification information and the responsible maintenance person information pertaining to said information communicating terminal device,

a first maintenance data readout means for accessing said first maintenance database, subject to said information communicating terminal device identification information, and reading out at least the responsible maintenance person information pertaining to said information communicating terminal device, and

a disorder contents transmission means for transmitting at least a part of said disorder contents to the portable remote terminal of the responsible maintenance person identified by accessing said responsible maintenance person information.

(22) The maintenance service support host apparatus set forth in Item (20) or (21) above, wherein said maintenance service support host apparatus is characterized in that it is further equipped with

an identification information receiving means for receiving the information communicating terminal device identification information sent from said information communicating terminal device if a disorder occurs in this terminal,

a second maintenance data memory means for memorizing a second maintenance database which links at least said information communicating terminal device identification information and the responsible maintenance person information and user information pertaining to said information communicating terminal device,

a second maintenance data readout means for accessing said second maintenance database, subject to said information communicating terminal device identification information, and reading out at least a part of the responsible maintenance person information or user information pertaining to said information communicating terminal device, and

a maintenance data transmission means for transmitting at least a part of said user information to the portable remote terminal of the responsible maintenance person identified by accessing said responsible maintenance person information.

If a disorder occurs in the information communicating terminal device, the progress of maintenance by the responsible maintenance person can be notified of to any contact person who has been designated beforehand.

(23) A maintenance service support host apparatus for connecting an information communicating terminal device and a stock control host apparatus via a communications network and supporting the maintenance services relating to said information communicating terminal device, wherein said maintenance service support host apparatus is characterized in that it has

a disorder processing information receiving means for receiving the disorder processing information sent from the portable remote terminal of the responsible maintenance person for said information communicating terminal device,

a progress-status information creating means for creating progress-status information based on said disorder processing information,

a progress-status information supply means for supplying said progress-status information via said communications network, an access person identification information acquisition means for acquiring access person identification information that identifies the person who accesses said progress-status information supply means, and

an information supply restriction means by which the type of information to be supplied from said progress-status information supply means is restricted in accordance with said access person identification information.

(24) The maintenance service support host apparatus set forth in Item (23) above, wherein said information supply restriction means is characterized in that supply of at least a part of said progress-status information is restricted.

(25) The maintenance service support host apparatus set forth in Item (23) or (24) above, wherein said maintenance service support host apparatus is characterized in that it has a restriction details memory means for memorizing a restriction details database which links at least said access person identification information and the restriction details pertaining to supply of said progress-status information from said information supply restriction means, and

a restriction details readout means for accessing said restriction details database, subject to said access person identification information, and then reading out the restriction details pertaining to supply of said progress-status information from said information supply restriction means,

and in that

the type of information to be supplied from said progress-status information supply means is restricted in accordance with said restriction details by said information supply restriction means.

Any contact person who has been designated beforehand can be supplied with the disorder processing information relating to the information communicating terminal device, through the communications network. Also, the type of information acquirable by the access person is restricted to prevent unauthorized access.

### BRIEF DESCRIPTION OF THE DRAWINGS

Other objects and advantages of the present invention will become apparent upon reading the following detailed description and upon reference to the drawings in which:

FIG. 1 is a diagram showing the total configuration of the maintenance service support system 100 pertaining to the present invention;

FIG. 2 is a functional block diagram showing an internal configuration of host computer 1 shown in FIG. 1;

FIG. 3 is a diagram showing the fault acceptance table 16a stored into a recording medium 16;

FIG. 4 is a diagram showing the disorder contents table 16b stored into recording medium 16;

FIG. 5 is a diagram showing the client information table 16c stored into recording medium 16;

FIG. 6 is a diagram showing the responsible maintenance person information table 16d stored into recording medium 16;

FIG. 7 is a diagram showing the consumable parts/materials acceptance table 16e stored into recording medium 16;

FIG. 8 is a timing chart explaining fault processing which forms part of the main operation pertaining to the present invention;

FIG. 9 is a timing chart explaining order processing which forms part of the main operation pertaining to the present invention;

FIG. 10 is a view showing an example of a screen mode in which the host computer 1 in FIG. 1 makes a display on the display screen of PC 2 during fault processing;

FIG. 11 is a view showing an example of a screen mode in which the host computer 1 in FIG. 1 makes a display on the display screens of cellular phones 3 and 4 during fault processing;

FIG. 12 is a view showing another example of a screen mode in which the host computer 1 in FIG. 1 makes a display on the display screen of PC2 during order processing;

FIG. 13 is a view showing another example of a screen mode in which the host computer 1 in FIG. 1 makes a display on the display screens of cellular phones 3 and 4 during order processing;

FIG. 14 is a view showing an example of a screen mode in which the cellular phone 3 in FIG. 1 transmits acceptance confirmation information or the like to PC2 during order processing; and

FIG. 15 is a table representing the relationship between the access person and display items, displayed at the copying machine maintenance information supply site opened by the host computer 1 of FIG. 1.

### DETAILED DESCRIPTION OF THE PREFERRED EMBODIMENTS

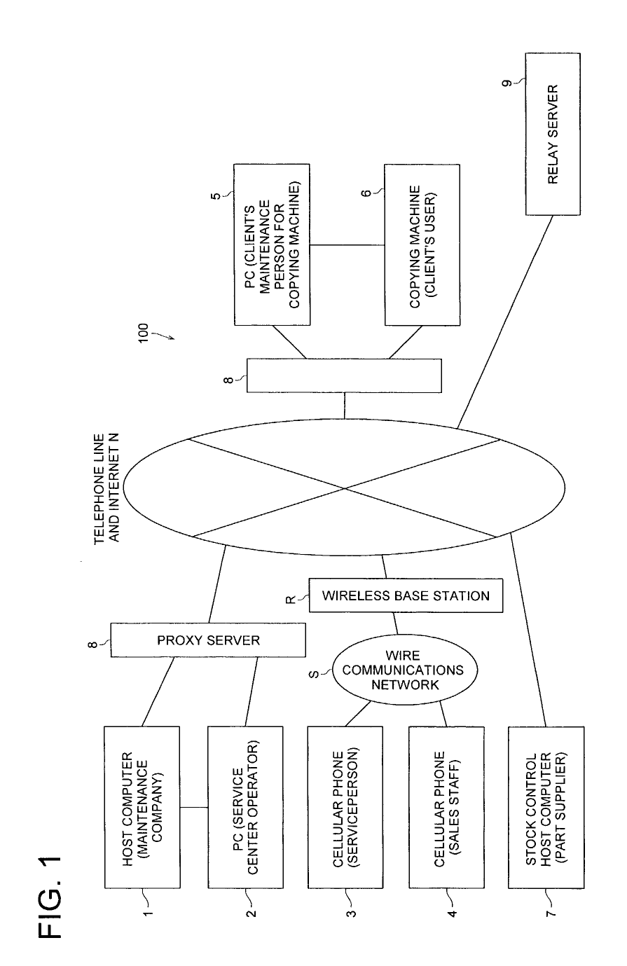

The preferred modes of embodiment of the present invention are described in detail below using drawings. First, configuration is described. FIG. 1 is a diagram showing the total configuration of the maintenance service support system 100 pertaining to a first embodiment of the present invention. In maintenance service support system 100, as shown in FIG. 1, the host computer 1 (maintenance management apparatus) of the maintenance company, the PC2 of the maintenance company's Service Center operator, the cellular phone 3 of the maintenance company's responsible serviceperson, the cellular phone 4 of the maintenance company's responsible sales section member, the PC5 of the client's responsible maintenance person for the copying machine, the copying machine 6 (maintenance target, namely, the apparatus to undergo maintenance servicing) of the client's user, the stock control host computer 7 of the part supplier, a proxy server 8, and a relay server 9 are connected via wire or wireless telephone lines and Internet N so as to enable data exchange and input/output.

In maintenance service support system 100, the host computer 1 as the maintenance servicing apparatus, or the copying machine 6 as the apparatus to undergo maintenance servicing, is connected to the Internet N via the proxy server 8 having a firewall function. Also, the cellular phones 3 and 4 can be connected to Internet N by being connected, via a wireless communications network S, to a wireless base station R that has been connected to Internet N. In addition, the relay server 9 is connected to Internet N via a public line or a dedicated line.

Although FIG. 1 shows the case that one host computer 1, one PC2, one cellular phone 3, one cellular phone 4, one PC5, one copying machine 6, and one stock control host computer 7 are connected directly or indirectly to telephone lines and Internet N, the number, locations, etc. of these system components are not limited. Furthermore, copying machine 6 can be connected directly to the relay server, not via proxy server 8 and Internet N, or can be connected to Internet N via any Internet service provider. An example in which copying machine 6 is connected to Internet N via proxy server 8 under this embodiment is explained below.

Host computer 1 is managed by the service company undertaking the maintenance of the copying machine 6, and processes fault correction process information relating to the copying machine installed at a remote location. More specifically, host computer 1 is connected to Internet N via the proxy server 8 functioning as the firewall for restricting the type of information passed through the host computer. Host computer 1 also receives, via relay server 9, the maintenance information on copying machine 6 that is transmitted therefrom. In accordance with the thus-received information, the host computer performs fault correction, part ordering, and status notification processes, including: sending the responsible serviceperson to the client site in case of a fault, contacting sales staff, confirming the stock of and ordering parts, exchanging fault processing information, recording fault processing results, and other operations.

In addition, host computer 1 opens a copying machine maintenance information supply site (not shown in the figure) on Internet N, and supplies the fault processing information and order processing information sent from the maintenance company. The fault processing information and the order processing information are information intended for the responsible maintenance person to identify the type of process to be performed on the copying machine 6 in which the disorder has occurred or which requires the replacement of consumable parts or materials. More specifically, the above-mentioned information includes not only at least a part of the information communicating terminal device identification information and responsible maintenance person information, but also order information on modification parts or consumable parts/materials, the planned date of delivery thereof to the client, and other information. Furthermore, host computer 1, after receiving fault notification or order notification information from copying machine 6, issues one host acceptance number for one fault or order and notifies this number to the PC5 of the client's responsible maintenance person for the copying machine. The latest information relating to fault processing, order processing, and other processes, can be acquired by making access to the copying machine maintenance information supply site, based on the host acceptance number.

PC2 is connected to an in-house line connected to a network such as a local area network (LAN), and is further connected to Internet N via proxy server 8 in order to receive various maintenance information from host computer 1 via Internet N and relay server 9 and display received information on the display apparatus. Under the directions of the Service Center operator, PC2 exchanges fault information and other information with host computer 1, cellular phones 3 and 4, PC5, copying machine 6, and stock control host computer 7, by exchanging electronic mail between these system components.

Cellular phones 3 and 4 are connected to wireless base station R via wireless communications network S, from which the cellular phones can then communicate via Internet N, access the copying machine maintenance information supply site provided by host computer 1, and exchange electronic mail. Cellular phone 3 is carried by the maintenance company's responsible serviceperson with him, and cellular phone 4 is carried by the maintenance company's responsible sales section member with him/her.

PC5 used by the client's responsible maintenance person for copying machine 6 is connected to an in-house line connected to a network such as a LAN, and is further connected to Internet N via proxy server 8. PC5 receives various maintenance information from host computer 1 and displays the information on the display apparatus. Under the directions of the Service Center operator, PC5 also exchanges fault information and other information with host computer 1, PC2, cellular phones 3 and 4, copying machine 6, and stock control host computer 7, by exchanging electronic mail between these system components.

Copying machine 6 is connected to PC5 via an in-house line in order to receive various data via relay server 9 and Internet N and transmit fault information or order information and information communicating terminal device identification information to host computer 1 relay server 9 and Internet N. The information communicating terminal device identification information is information that univocally identifies copying machine 6, and more specially, includes the serial number, IP address, MAC address, and other information of the copying machine. In this embodiment, however, an electronic mail address is used instead. Copying machine 6 has an assigned electronic mail address and exchanges information with host computer 1 and PC5 by electronic mail. The copying machine also has a facsimile message transmission function.

Stock control host computer 7 is a computer to be managed by the supplier of parts and consumable parts/materials during the maintenance of the copying machine 6. This computer is installed in a place different from that of the host computer 1, connected to a printer (not shown in the figure) via an in-house line, and further connected to Internet N. Stock control host computer 7 manages stock information on the modification parts and consumable parts/materials for the copying machine 6 installed in the relevant maintenance service area. The stock information is information used to confirm the presence of the corresponding modification parts in specific sections at a particular time, and more specifically, identifies the presence/absence of the modification parts, the quantities thereof (when present), the planned date of delivery thereof (when out of stock), and other factors. Stock control host computer 7, after receiving parts stock confirmation instructions and order information from host computer 1, PC2, and cellular phone 3, executes stock confirmation, order acceptance, etc. in accordance with the received information, and responds by sending electronic mail on stock confirmation results (stock present/absent) and on order acceptance.

Proxy server 8 is provided on the in-house lines of both the client company and the maintenance company, and has a firewall function that restricts the type of information passed through the proxy server. More specifically, this server restricts the types of information to be received via Internet by host computer 1 and copying machine 6.

Relay server 9 is provided outside the in-house lines of the client company and the maintenance company, and is connected to network N. Relay server 9 functions as a relay between the host computer 1 and copying machine 6 in both of which the server is provided, and exchanges maintenance information on copying machine 6. Since proxy server 8 has a firewall function, the above creates security-associated problems and makes it difficult to acquire the information of the host computer 1 and copying machine 6 from outside (network N). In this embodiment, therefore, information exchange between host computer 1 and copying machine 6 is possible by providing a specific relay server 9 that permits information exchange between host computer 1 and copying machine 6.

More specifically, during the fault correction process described later in this document, relay server 9, after receiving fault information and the electronic mail address from copying machine 6, transfers the information and the electronic mail address to host computer 1 and transfers to copying machine 6 the fault processing information received from host computer 1.

The line form of the Internet N is shown as a loop in FIG. 1. This form, however, is arbitrary. Also, connection between terminals can be of the wire or wireless type. In terms of information management reliability, however, it is desirable that the network be of the form provided with the appropriate security measures so as to authorize access by specific persons only. Internet N includes, for example, a telephone line network, ISDN lines, dedicated lines, a mobile communications network, a communications satellite network, a CATV line network, other communications networks or lines, Internet service providers who connect these communications networks or lines, base stations, and/or other elements. Repeaters such as the routers for analyzing the data transmitted and received, establishing transmission routes, and transferring information, and line concentrators such as hubs equipped with the required number of ports.

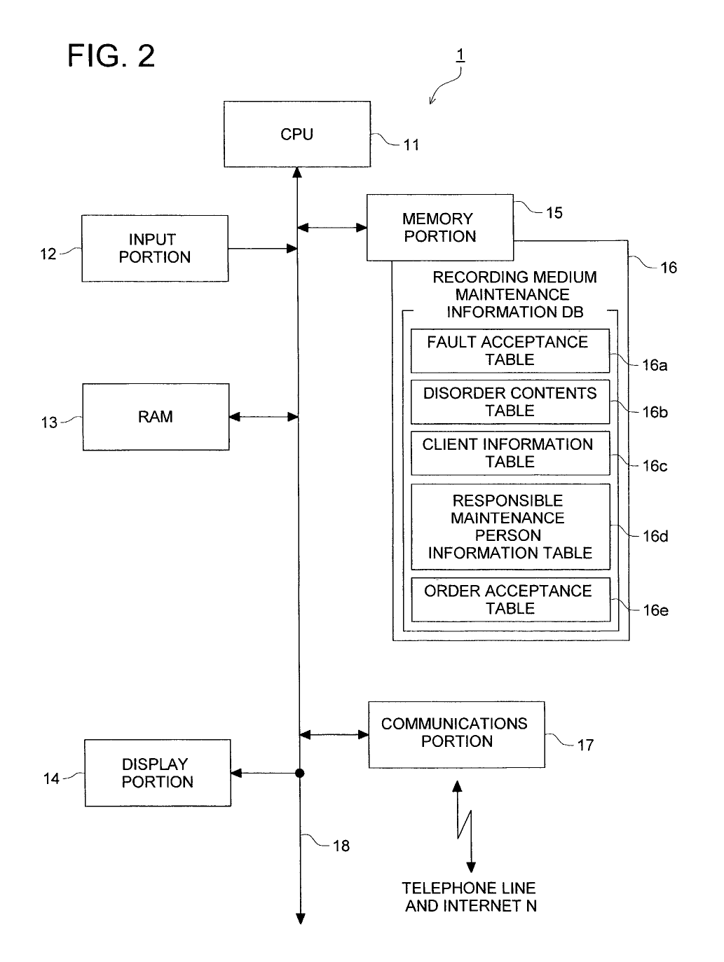

Next, the internal configuration of the host computer 1 shown in FIG. 1 is described using FIG. 2. FIG. 2 is a block diagram showing the functional configuration of the host computer 1. As shown in FIG. 1, host computer 1 comprises a CPU 11, an input portion 12, a RAM 13, a display portion 14, a memory portion 15, a recording medium 16, and a communications portion 17. Each portion, except recording medium 16, forms a computer connected using a bus 18.

CPU (Central Processing Unit) 11 reads out a program from the memory portion 15, unfolds the program onto the RAM 13, and provides centralized control of each portion in accordance with the corresponding program. That is to say, in accordance with the corresponding program that has been unfolded onto RAM 13, CPU 11 executes the fault correction, part ordering, and status notification processes described later in this document, then stores processing results into RAM 13, and displays them on display portion 14. After this, the processing results that have been stored into RAM 13 are saved in the required internal area of the memory portion 15 or recording medium 16.

CPU 11 also functions as a disorder contents table data readout means, a first maintenance data readout means, a second maintenance data readout means, a progress-status information creating means, a progress-status information supply means, an access person ID acquisition means, an information supply restriction means, and a restriction details data readout means.

Input portion 12 consists of a keyboard equipped with character/numeric data input keys, cursor control keys, and function keys, and a mouse which is a pointing device with click buttons. Keyboard operating signals and mouse operating signals are sent from input portion 12 to CPU 11 as input signals.

During each process executed and controlled by CPU 11, RAM (Random Access Memory) 13 forms a temporary storage area for all or some of the programs (or all or part of the data) read out from memory portion 15 or recording medium 16.

Display portion 14 consists of a liquid-crystal display (LCD) unit or a cathode ray tube (CRT) unit and other elements. This display portion displays data on its screen in accordance with the display signal instructions sent from CPU 11.

Memory portion 15 is composed of a nonvolatile semiconductor memory such as a hard disk (HD). This memory portion memorizes the programs executable by host computer 1, and data that has undergone processing by various programs. Also, memory portion 15 has a removably mounted recording medium 16, which is made of a magnetic or optical recording material. Programs are stored in the form of the program codes which can be read by the computer, and CPU 11 sequentially executes functions based on the program codes.

Memory portion 16 can be configured so that part or all of the programs and data stored into the memory portion will be acquired at communications portion 17 from external units via transmission media such as communications lines before being stored. Conversely, memory portion 16 can also be configured so that the above programs and data will be transmitted from communications portion 17 via transmission media and then installed in external units. The programs and data include those which are realized by the firmware that has been integrated with the hardware of the computer.

Recording medium 16 contains a fault acceptance table 16a, a disorder contents table 16b, a client information table 16c, a responsible maintenance person information table 16d, an order acceptance table 16e, and the like, in an updatable file format. Recording medium 16 also functions as a notification destination information memory means, a specific progress-status information memory means, a disorder contents table memory means, and a restriction information memory means.

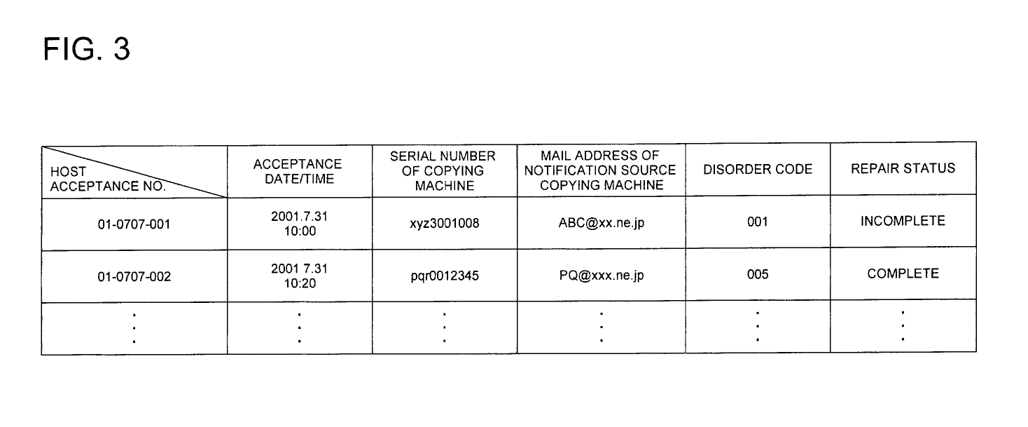

During fault processing, if a disorder message relating to copying machine 6 is detected, the fault acceptance table 16a shown in FIG. 3 will assign the appropriate host acceptance number to the disorder message and memorize the date/time of acceptance, the serial number of the copying machine, the electronic mail address thereof, the disorder code identifying the type of fault, repair status, and other information.

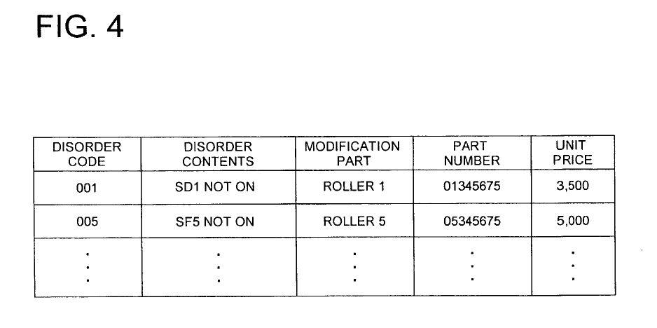

The disorder contents table 16b shown in FIG. 4 is a file in which the disorder code (disorder information) created by copying machine 6 in accordance with the disorder that was detected therein, and the modification part information corresponding to the disorder in copying machine 6 has been linked. Disorder contents table 16b has known data structure, in which the above-mentioned disorder code and details of the disorder that occurred in copying machine 6 should, preferably, be linked.

The modification part information here refers to information on parts related to the disorder that occurred in copying machine 6, and on the parts whose replacement by the responsible maintenance person enables disorder recovery, and more specifically, the information contains the names, type numbers, unit prices, etc. of the modification parts. Also, the disorder contents mentioned above refer to information that enables the disorder in copying machine 6 to be recognized, even by third parties not present at the user site, and more specifically, contains the statement, pictorial, voice, or other media that represent the disorder.

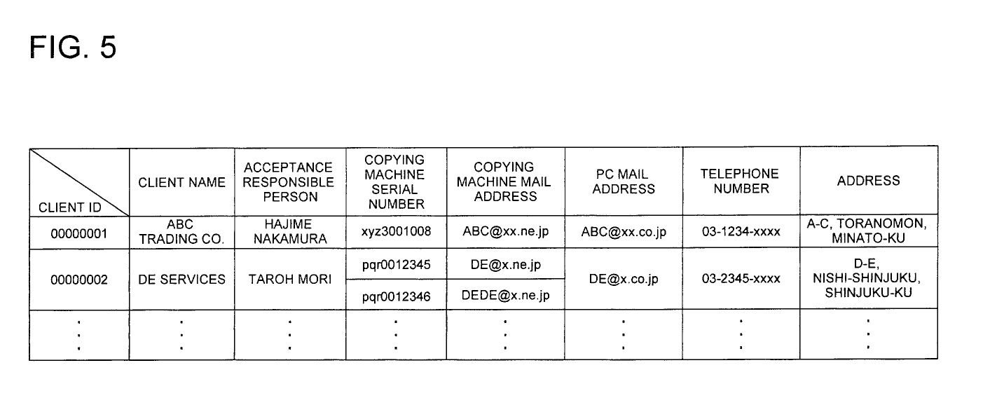

The client information table 16c shown in FIG. 5 memorizes client information. The client information here is information relating to the corporate person or individual who owns or uses copying machine 6, and more specifically, contains the identification code number, name, electronic mail address, telephone number, sand address of the client, the name of the acceptance responsible person, etc.

Also, as with the responsible maintenance person information table 16d described below, client information table 16c functions as a second maintenance data memory means as well.

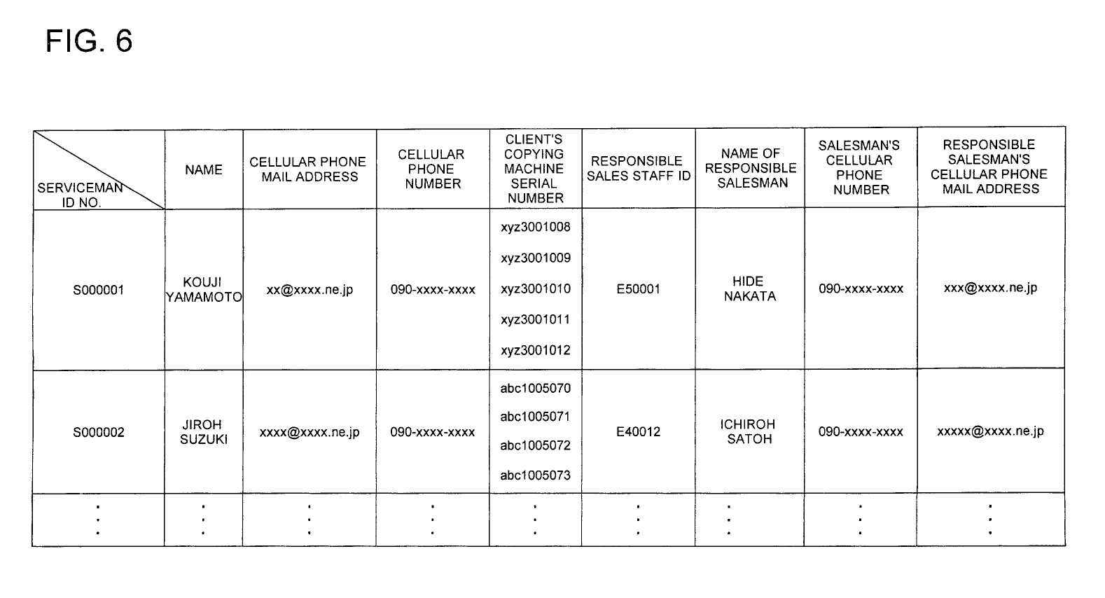

The responsible maintenance person information table 16d shown in FIG. 6 memorizes information on the responsible maintenance person. The responsible maintenance person information is the information necessary to transmit fault details, client information and other maintenance information to the serviceperson responsible for the maintenance of copying machine 6, and thus to notify the responsible maintenance person's name to the user of the copying machine. More specifically, the responsible maintenance person information contains the ID, name, telephone number, and electronic mail address of the responsible maintenance person, the ID, telephone number, and electronic mail address of the responsible sales staff, etc.

Also, responsible maintenance person information table 16d functions as a first maintenance data memory means as well, and similarly to the above-described client information table, functions as a first maintenance data memory means as well.

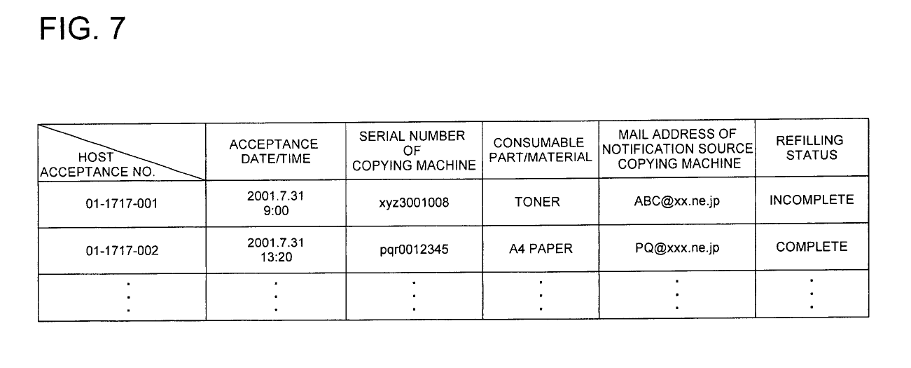

During order processing, when an order message from copying machine 6 is detected, the order acceptance table 16e shown in FIG. 7 will assign the appropriate host acceptance number to the order message and memorize the date/time of acceptance, the serial number and electronic mail address of the copying machine, the names of the corresponding consumable parts or materials, stock status, etc.

Communications portion 17 consists of: a modem (modulator/demodulator) or terminal adapter (TA) for communicating with the system components shown in FIG. 1 and to which host computer 1 is connected (namely, cellular phones 3 and 4, PC5, copying machine 6, and stock control host computer 7), or with the external units that are connected via a network such as a LAN (namely, PC2); or a communications unit for exchanging various information by telephone or the like.

Communications portion 17 also functions as a disorder processing information receiving means, a progress-status information transmission means, a disorder information receiving means, a disorder contents transmission means, a maintenance data transmission means, and a disorder processing information receiving means.

The various information exchanged between host computer 1 (maintenance management apparatus) and copying machine 6 (the apparatus to undergo maintenance) is converted into the required data structure, the required encryption data, and the required protocol, before being exchanged. The data structure here contains, for example, a mark-up language [such as XML which includes meta-files (information for managing data) or tag-containing HTML], script text written in Java (registered trademark) or in Perl, binary data forming the programs themselves, etc. Encryption refers to converting data in accordance with prescribed rules and making its decoding extremely difficult in order to prevent document data, image data, and other digital data from being stolen or falsified by third parties during communication via a network such as the Internet. Returning encrypted data to the original status to enable decoding is referred to as de-encryption.

Encryption and de-encryption usually uses a “key”, which functions as a code table, and there is an open-key code scheme that uses two independent keys for encryption and de-encryption each, and a common-key code scheme that uses the same key for both. Examples of the former scheme include RSA, E1Gama1 coding, elliptic curve coding, etc., and examples of the latter scheme include the U.S.A. Government standard DES, IDEA, FEAL, MISTY, etc. In the present invention, any of the above coding schemes can be used. The required protocol refers to the communications procedure prescribed to ensure that normal communication takes place between the maintenance management apparatus and the apparatus to undergo maintenance, and this protocol defines the types of lines to be used, communications speeds, data error detection, data error correction, duplex communications/half-duplex communications, etc. TCP/IP is used for the Internet, and SMTP (Send Mail Protocol for electronic mail transmission), HTTP (Hyper Text Transfer Protocol), and VPN (Virtual Private Network) are further used on TCP/IP. In the present invention, the applicable types of protocols are not limited to the above and either of the above can be used as appropriate.

Next, operation is described.

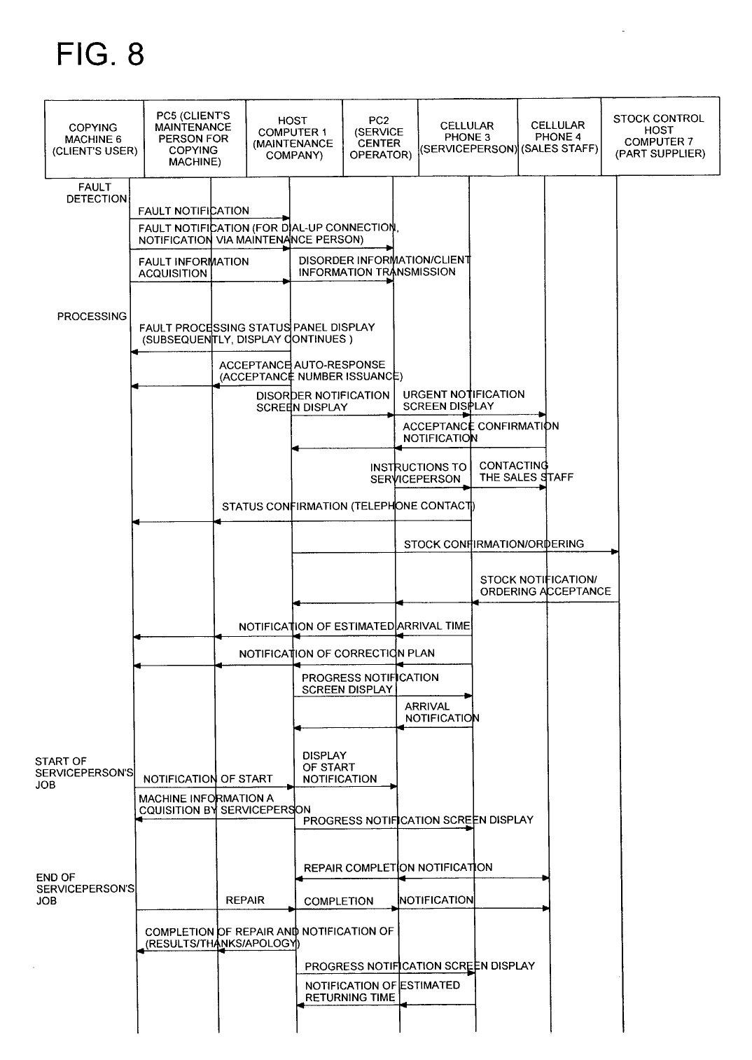

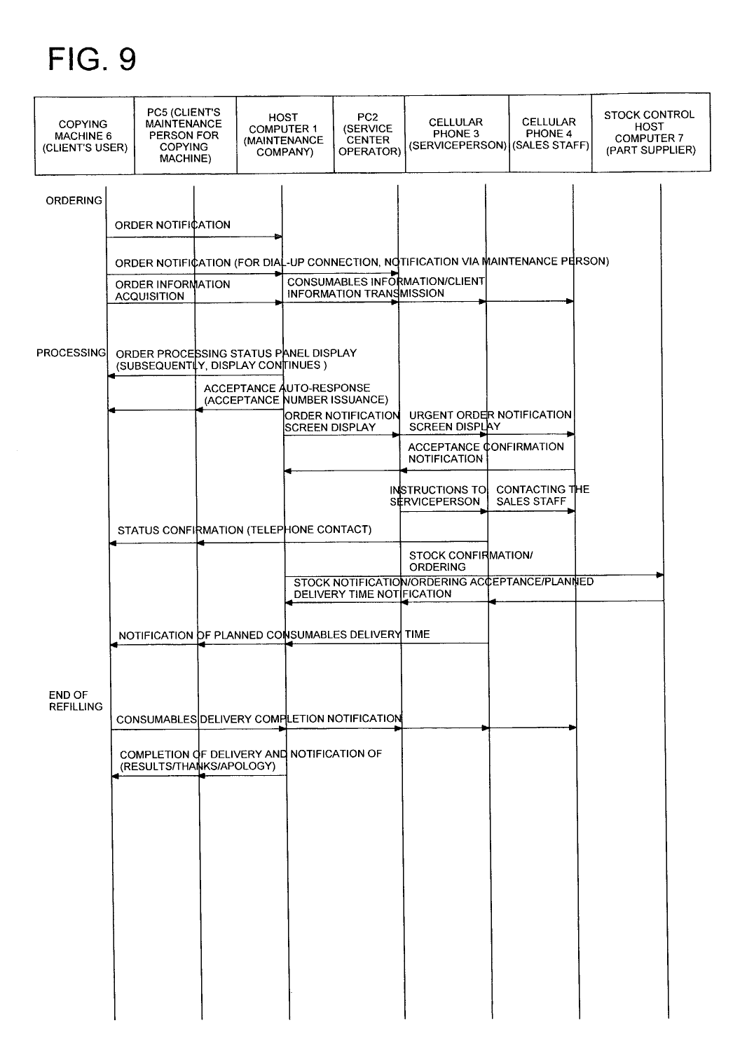

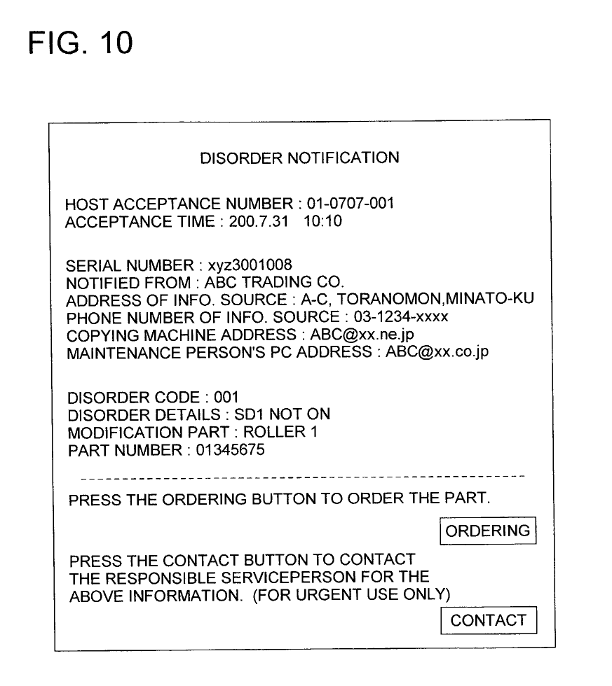

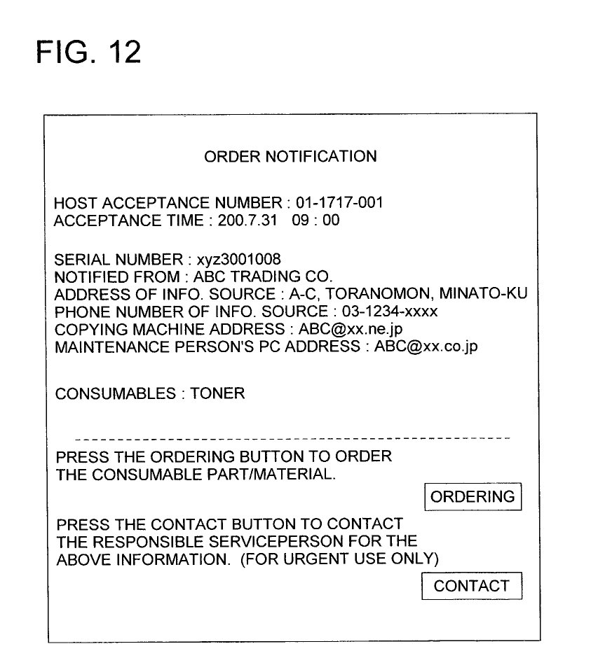

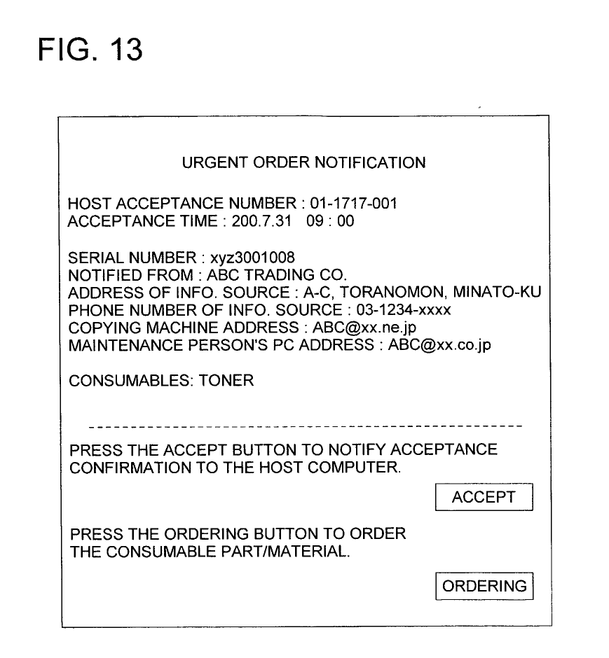

Fault processing that forms part of the main operation pertaining to the present invention is described using the timing chart of FIG. 8, the examples of screen display shown in FIGS. 10, 11, and 14. Also, order processing is described using the timing chart of FIG. 9 and the examples of screen display shown in FIGS. 12 and 13.

The description of operation assumes that the programs for implementing each process shown in the timing charts of FIGS. 8 and 9 are prestored within memory portion 15 in the format of the program codes readable by the computer and that the CPU 11 sequentially executes functions based on these program codes. CPU 11 can also sequentially execute the characteristic functions of this embodiment by using the programs and data supplied from outside via communications portion 17.

First, the fault correction process by maintenance service support system 100 is described using the timing chart of FIG. 8.

If a fault occurs in the copying machine 6 of the client's user, copying machine 6 will transmit the appropriate disorder code to the host computer 1 of the maintenance company by electronic mail to notify to the host computer that the fault has occurred. The copying machine 6, if set to DIAL-UP connection, will transmit the disorder code to host computer 1 via the PC5 of the maintenance person by electronic mail. If the fault disables copying machine 6 to send or receive electronic mail, copying machine 6 will send facsimile to the maintenance company and notify the electronic mail address and disorder code of the copying machine 6 to the maintenance company.

Host computer 1 not only stands by for fault notification from copying machine 6 as described above, but also periodically monitors for faults in copying machine 6 and conducts active maintenance.

Host computer 1 also accesses the client information table 16c of FIG. 5 and acquires the serial number of the copying machine 6, based on the electronic mail address received therefrom. Next, the acceptance date/time of the fault message, the serial number, electronic mail address, disorder code, and repair status of the copying machine 6 in which the fault occurred are written into the fault acceptance table 16a of FIG. 3 and the appropriate host acceptance number is assigned in the order that the fault information has been acquired.

In addition, host computer 1 transmits electronic mail to copying machine 6, then starts the fault processing panel display process on the display screen of the copying machine 6, and displays the latest fault processing information until maintenance processing has been completed. Information on fault message acceptance by the maintenance company, and the latest fault processing information including the estimated time of the serviceperson's arrival at the client site are displayed during the fault processing panel display process.

Furthermore, host computer 1 transmits the host acceptance number to the PC5 of the client's maintenance person by electronic mail and displays this number on the display screen of the copying machine 6 as well. The maintenance person of the client, and the user can always acquire the latest fault processing information by making access to the maintenance company-supplied copying machine maintenance information supply site, based on the acceptance number.

After this, host computer 1 views the disorder contents table 16b of FIG. 4 by using the disorder code and electronic mail address that have been acquired from copying machine 6, and acquires fault details. Also, the client information table 16c of FIG. 5 is viewed and the corresponding client information is acquired. At this time, if automatic part ordering is already specified, host computer 1 will transmit the modification part names and part numbers contained in the disorder contents, to the stock control host computer 7 by electronic mail, and execute parts stock confirmation and ordering.

Host computer 1 displays the thus-obtained disorder contents and client information on the display screen of PC2 (see FIG. 10 for the display). In the disorder notification screen mode, an ordering button and a contact button are displayed in addition to the host acceptance number, the acceptance time, the serial number and electronic mail address of the copying machine 6, the client information, the disorder contents, and the names and identification numbers of the modification parts. The ordering button, however, is not displayed if the modification parts have already been ordered via host computer 1.

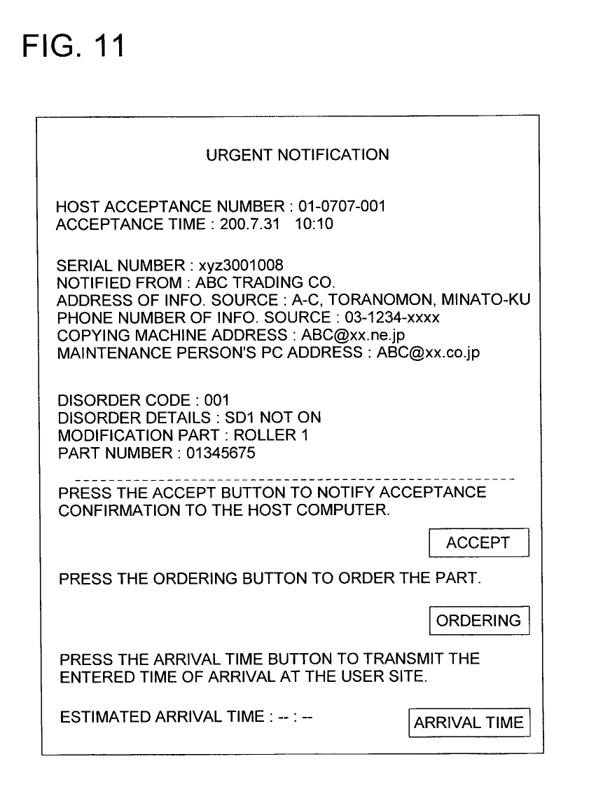

When the contact button in the disorder notification screen mode of the PC2 is pressed by the Service Center operator, electronic mail will be sent to cellular phones 3 and 4 and these cellular phones will enter an urgent notification screen mode (see FIG. 11). In the urgent notification screen mode, an acceptance button, an ordering button, an arrival time input field, and an arrival time button are displayed in addition to the host acceptance number, the acceptance time, the serial number and electronic mail address of the copying machine 6, the client information, the disorder contents, and the names and identification numbers of the modification parts. The ordering button, however, is not displayed if the modification parts have already been ordered via host computer 1 or PC2.

At this time, when the acceptance button displayed on the screen of cellular phone 3 or 4 is pressed, electronic mail on the notification of acceptance confirmation will be transmitted to host computer 1 and PC2. After receiving the electronic mail, host computer 1 will transmit fault processing instructions electronic mail to cellular phone 3 and transmit to cellular phone 4 the electronic mail notifying it of the details relating to the instructions transmitted to cellular phone 3. The serviceperson with cellular phone 3, after receiving the fault processing instructions electronic mail, will check details of the fault status with the maintenance person of the client by using the phone. The maintenance person of the client will then confirm the fault status of the copying machine 6 in detail and notify the results to the serviceperson.

When automatic part ordering is executed by host computer 1, when the ordering button in the disorder notification screen mode of the PC2 is pressed by the Service Center operator, or when the ordering button on the screen of the cellular phone 3 is pressed by the serviceperson, electronic mail on stock confirmation and on ordering will be automatically transmitted to the stock control host computer 7 and the stock confirmation and ordering of the modification parts displayed in the disorder notification screen mode will be executed.

After receiving the parts stock confirmation and ordering electronic mail from either host computer 1, PC2, or cellular phone 3, stock control host computer 7 responds by sending electronic mail to host computer 1, PC2, or cellular phone 3 to notify stock status and ordering acceptance status to each. Also, the ordering information is not only displayed on the display screen of the stock control host computer 7, but also printed out from the printer connected thereto.

In addition, when, after entry of the estimated time of arrival at the client site from cellular phone 3, the arrival time button is pressed by the serviceperson, cellular phone 3 will send electronic mail to host computer 1, PC2, PC5, and copying machine 6 to notify the estimated arrival time to each.

Furthermore, in accordance with the detailed fault status confirmed above, the serviceperson notifies his correction plan to host computer 1, PC2, PC5, and copying machine 6 by sending electronic mail through cellular phone 3.

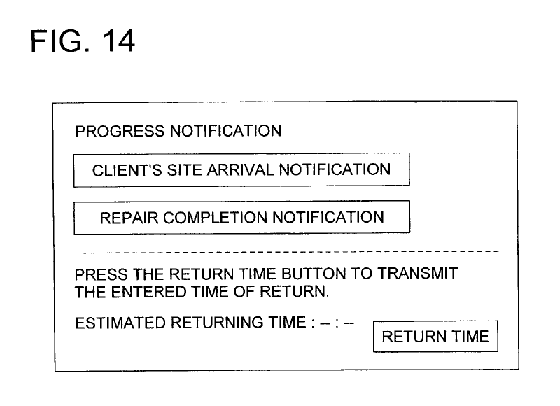

The host computer 1, after receiving the electronically mailed correction plan from cellular phone 3, transfers the mailed correction plan to copying machine 6 and PC5 and sends progress notification display data (see FIG. 14) to cellular phone 3 by electronic mail. In this progress notification screen mode, a client site arrival notification button, a repair completion notification button, an estimated returning time input field, a returning time button are also displayed. After the serviceperson has arrived at the client site and pressed the client site arrival notification button in the progress notification display screen mode of the cellular phone 3, electronic mail notifying his arrival at the client site is sent from cellular phone 3 to host computer 1 and PC2.

Following this, after the serviceperson has started repairing copying machine 6 at the client site and entered a repair starting message from copying machine 6, the entered message is sent from copying machine 6 to host computer 1 by electronic mail. After receiving the electronic mail, host computer 1 sends repair starting mail to PC2 and makes a display on the display screen of the PC2 to indicate that repairing has been started.

Host computer 1 also acquires the serial number of the copying machine 6 by viewing the fault acceptance table 16a of FIG. 3 in accordance with the electronic mail address of the copying machine 6. After this, host computer 1 acquires the machine information of the copying machine 6 by viewing the appropriate machine information table (not shown in the figure) in accordance with the serial number, then sends the machine information to copying machine 6 by electronic mail, and displays the same information on the display screen of the copying machine 6. The machine information means, for example, the information required for fault processing of the copying machine 6, such as the past fault history thereof and version information. Next, host computer 1 once again sends the progress notification display data to cellular phone 3 by electronic mail and displays the data. At this time, the client site arrival notification button is not displayed.

When the repair of the copying machine 6 is completed and the repair completion notification button of the cellular phone 3 is pressed by the serviceperson, cellular phone 3 will send electronic mail to host computer 1, PC2, and cellular phone 4 to notify to each that the repair has been completed. Or when repair completion notification is entered from copying machine 6 by the serviceperson, copying machine 6 will send electronic mail to host computer 1, PC2, and cellular phone 4 to notify to each that the repair has been completed.

After receiving the repair completion notification mail, PC2 displays repair completion on its display screen. Also, host computer 1 updates the display of “INCOMPLETE” in the repair progress field of the fault acceptance table 16a to “COMPLETE”, then after calculating the time that has elapsed from the acceptance date/time to the update time, reads out the fault processing results prestored within recording medium 16 according to the time that has elapsed, and a routine statement of thanks, apology, or the like, and sends the fault processing results and the statement to PC5 and copying machine 6 by electronic mail.

Following this, host computer 1 sends the progress notification display data to cellular phone 3 by electronic mail. At this time, however, neither the client site arrival notification button or the repair completion notification button is displayed. After, in this progress notification screen mode, any time has been entered in the estimated returning time input field, and the returning time button has been pressed, by the serviceperson, electronic mail notifying the estimated returning time to host computer 1 and PC2 is sent from cellular phone 3 to complete the fault correction process of the maintenance service support system 100.

Next, order processing by maintenance service support system 100 is described using the timing chart of FIG. 9.

When the consumable parts/materials at the client's user site of the copying machine 6 are consumed to fixed quantities, the names of the consumable parts/materials will be sent from copying machine 6 to the host computer 1 of the maintenance company by electronic mail to notify the necessity for ordering. The copying machine 6, if set to DIAL-UP connection, will send ordering notification electronic mail to host computer 1 via the PC5 of the maintenance person. At this time, it is possible to select either the method of ordering consumable parts/materials from copying machine 6 to the stock control host computer 7, or the method of ordering via the serviceperson or the sales staff.

If the fault has disabled copying machine 6 to send or receive electronic mail, copying machine 6 will send facsimile to the maintenance company and notify the electronic mail address of the copying machine 6 and the names of the consumable parts/materials to the maintenance company.

Host computer 1 periodically monitors the necessity for ordering concerning the copying machine 6 and conducts active maintenance. If the necessity for ordering is recognized during periodic monitoring, the electronic mail address of the copying machine 6 and the names of the consumable parts/materials will be acquired from copying machine 6 by electronic mail.

Next, host computer 1 views the client information table 16c of FIG. 5 and acquires the client ID of the copying machine 6, the name of the client, the serial number of the copying machine 6, and other client information, in accordance with the electronic mail that has been received from copying machine 6. After this, the acceptance date/time of the order notification, the serial number and electronic mail address of the orderer's copying machine 6, the names of the consumable parts/materials, and stock status are written into the order acceptance table 16e of FIG. 7 and the appropriate host acceptance number is assigned in the order that the order notification has been received.

In addition, host computer 1 transmits electronic mail to copying machine 6, then starts the order processing status panel display process on the display screen of the copying machine 6, and displays the latest order processing information until order processing has been completed. Information on order notification acceptance by the maintenance company, and the latest order processing information including the planned time of delivery of the consumable parts/materials are displayed in the order processing status panel display mode.

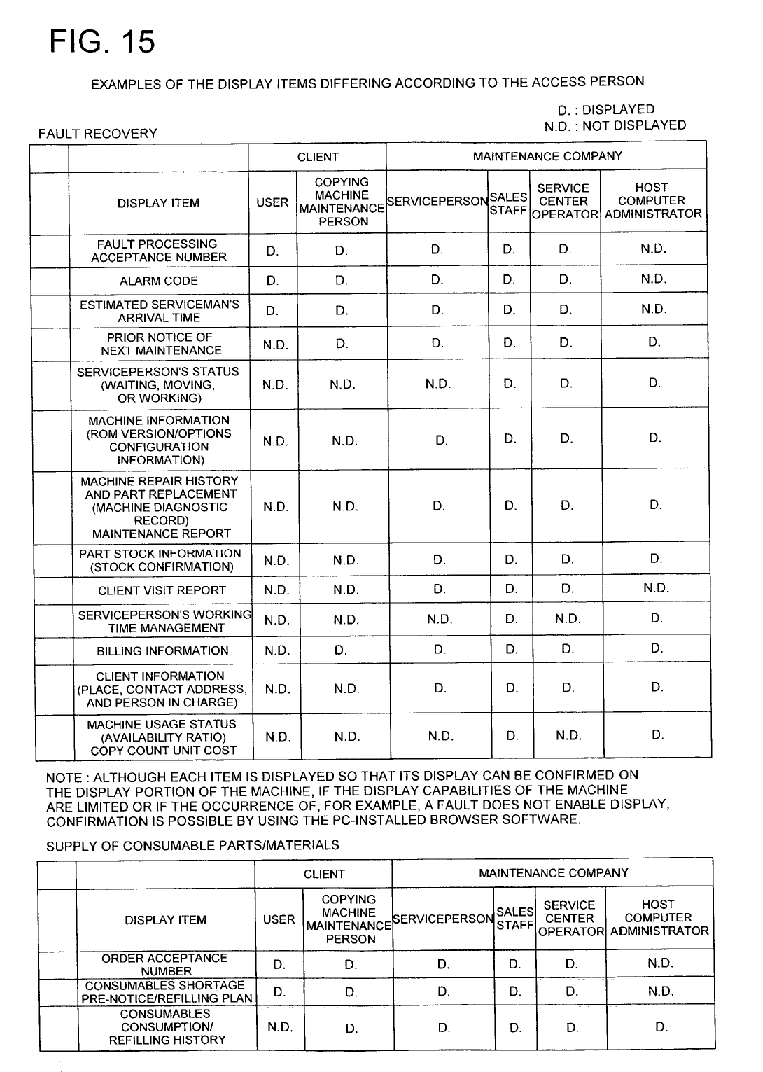

Furthermore, host computer 1 transmits the host acceptance number to the PC5 of the client's maintenance person by electronic mail and displays this number on the display screen of the copying machine 6 as well. The maintenance person of the client, and the user can always acquire the latest order processing information by making access to the maintenance company-supplied copying machine maintenance information supply site, based on the acceptance number. The items displayed on this copying machine maintenance information supply site, however, differs according to the access person (see FIG. 15).

After this, host computer 1 displays at PC2 the ordering-notified consumable parts/materials names, the corresponding client information, etc., as shown in FIG. 12). In this ordering notification screen mode, an ordering button and a contact button are displayed in addition to the host acceptance number, the acceptance time, the serial number and electronic mail address of the copying machine 6, the client information, and the names of the consumable parts/materials.

When the contact button in the ordering notification screen mode of the PC2 is pressed by the Service Center operator, electronic mail will be sent to cellular phones 3 and 4 and these cellular phones will enter an urgent ordering screen mode (see FIG. 12).

In the urgent ordering notification screen mode, an acceptance button and an ordering button are displayed in addition to the host acceptance number, the acceptance time, the serial number and electronic mail address of the copying machine 6, the client information, and the names of the consumable parts/materials. The ordering button, however, is not displayed if modification parts have already been ordered via PC2.

At this time, when the acceptance button displayed on the screen of cellular phone 3 or 4 is pressed, electronic mail on the notification of acceptance confirmation will be transmitted to host computer 1 and PC2. After receiving the electronic mail, host computer 1 will transmit order processing instructions electronic mail to cellular phone 3 and transmit to cellular phone 4 the electronic mail notifying it of the details relating to the instructions transmitted to cellular phone 3. The serviceperson with cellular phone 3, after receiving the order processing instructions electronic mail, will check details of the fault status with the maintenance person of the client by using the phone. The maintenance person of the client will then confirm the consumable parts/materials status of the copying machine 6 in detail and notify the results to the serviceperson.

When automatic consumable parts/materials ordering by host computer 1 is already specified, when the ordering button in the disorder notification screen mode of the PC2 is pressed by the Service Center operator, or when the ordering button on the screen of the cellular phone 3 is pressed by the serviceperson, electronic mail on stock confirmation and on ordering will be transmitted to the stock control host computer 7, where the stock of the consumable parts/materials required will be confirmed and ordering executed.

After receiving the consumable parts/materials stock confirmation and ordering electronic mail from PC2 or cellular phone 3, stock control host computer 7 responds by sending electronic mail to PC2 to notify stock status, order acceptance status, and the planned consumable parts/materials delivery time to PC2. Also, the ordering information is not only displayed on the display screen of the stock control host computer 7, but also printed out from the printer connected thereto.

After receiving the above electronic mail from stock control host computer 7, cellular phone 3 notifies the planned consumable parts/materials delivery time to host computer 1, PC5, and copying machine 6, by electronic mail.

When the consumable parts/materials for the copying machine 6 are delivered and the copying machine is refilled with the necessary the consumable parts/materials, copying machine 6 will send electronic mail to host computer 1, PC2, and cellular phones 3 and 4 to notify to each that the refilling operation has been completed.

After receiving the refilling operation completion notification mail, PC2 displays refilling operation completion on its display screen. Also, host computer 1 updates the display of “INCOMPLETE” in the refilling operation progress field of the order acceptance table 16e to “COMPLETE”, then after calculating the time that has elapsed from the acceptance date/time to the update time, reads out the order processing results prestored within recording medium 16 according to the time that has elapsed, and a routine statement of thanks, apology, or the like, and sends the order processing results and the statement to PC5 and copying machine 6 by electronic mail to complete the order processing operation of the maintenance service support system 100.

As described above, in this embodiment, if a fault occurs in copying machine 6 or when the quantities of its consumable parts or materials decrease, it is possible, just by performing very simple input operations between host computer 1, PC2, cellular phones 3 and 4, PC5, copying machine 6, and stock control host computer 7, to activate the maintenance service support system 100 to execute information notification on faults and consumable parts/materials, response status notification by the maintenance company, and the stock confirmation and ordering of modifications parts and consumable parts/materials, via communications lines.

In the maintenance service support system 100 that applies the present invention, since active maintenance occurs, copying machine 6 can always be maintained in its best condition. Also, a sense of unease can be removed from the client since information on fault processing by the maintenance company is constantly sent to the client by electronic mail.

In addition, even if a fault occurs in copying machine 6 and disables to send or receive electronic mail, since fault information is sent from coping machine 6 to the maintenance company by facsimile, the maintenance company can acquire fault information and order information on copying machine 6. In the meantime, even when copying machine 6 cannot make a screen display, since electronic mail is sent from host computer 1 to PC5 to notify the fault correction acceptance number or the order acceptance number to PC5, the responsible maintenance person of the client can access the copying machine maintenance information supply site and always obtain the latest fault processing information based on the acceptance number.

The above description of this embodiment relates to a preferred example of a printing control system based on the present invention, and the described embodiment is not limited by this example.

It has been described that for example, when copying machine 6 cannot communicate, it conducts fault notification or order notification to the maintenance company by facsimile. However, even when copying machine 6 can make a screen display and/or communicate, copying machine 6 can also send fault information or order information by electronic mail and further send them by facsimile transmission. In addition, although it has been described that, in case of a fault in copying machine 6 or during the placement of an order, copying machine 6 displays a fault processing status panel or order processing status panel on its display screen, fault information or order information can also be printed out using the printing function of the copying machine 6 or from the client's printer (or the like) connected thereto through the LAN, in order to enable the occurrence of the fault or the shortage of consumable parts or materials to be readily detected.

Although it has been described that, except when fault status confirmation notification from cellular phone 3 to PC5 and copying machine 5 takes place by telephone, information is transmitted by electronic mail, various information can, of course, be transmitted by combining telephone, electronic mail, a website, and/or the like, according to the particular needs.

The tables stored within the host computer 1 of the above-described embodiment are only examples in the embodiment of the present invention. For example, although, in the disorder contents table 16b of FIG. 5, one modification part corresponds to one disorder code, a plurality of modification parts can also be made to exist.

In addition, although an ordering button is displayed in the screen display mode supplied from host server 1 to PC2 and cellular phones 3 and 4, automatic part ordering from host server 1 without the above button being displayed is also possible.

Besides, the further detailed configurations and further detailed operation of each terminal which constitutes the maintenance service support system 100, and of other system components, can also be modified, as appropriate, within the range that does not deviate from the intended purpose of the present invention.

Furthermore, although electronic mail has been used as information communicating terminal device identification information in this embodiment, it is also possible to use information that univocally identifies the information communicating terminal device, such as the serial number and MAC address thereof.

Also, although it has been described that, in this embodiment, after receiving fault information from copying machine 6, host computer 1 automatically sends electronic mail and performs processes such as contacting the serviceperson, ordering modification parts, and repairing the copying machine 6, this copying machine can likewise be refilled with consumable parts or materials by applying the present invention. For example, if maintenance service support system 100 is configured so that when the paper, toner, or other consumable parts or materials in copying machine 6 are consumed to fixed quantities, automatic notification from copying machine 6 to host computer 1 will occur, followed by automatic stock confirmation and ordering from host computer 1 to the stock control host computer 7, the shortage of the consumable parts or materials in copying machine 6 will not occur.

Furthermore, the display screen modes in this embodiment, such as disorder notification screen mode, urgent notification screen mode, and progress notification screen mode, are examples of display, and actual display screen modes are, of course, not limited thereto.

Also, the tables stored within the host computer 1 of the above-described embodiment are only examples in the embodiment of the present invention. For example, although, in the disorder contents table 16b of FIG. 5, one modification part corresponds to one disorder code, a plurality of modification parts can also be made to exist.

Besides, the further detailed configurations and further detailed operation of each terminal which constitutes the maintenance service support system 100, and of other system components, can also be modified, as appropriate, within the range that does not deviate from the intended purpose of the present invention.

According to the present invention, the following effects can be obtained:

(1) Information exchange between the client and the maintenance company, part ordering, serviceperson schedule management, and other operations can be performed using very simple procedures. Therefore, the efficiency of the operator's jobs is improved which, in turn, enables significant reduction in the time required for maintenance, and leads to reduction in personnel costs. In addition, if a fault or other problems occur in the information communicating terminal device, the serviceperson can not only respond quickly, but also conduct maintenance operations so that the information communicating terminal device can always be operated in its best condition.

(2) The information required for recovery of the intended information communicating terminal device from the disorder status can be immediately transmitted to the responsible maintenance person.

(3) The progress of disorder processing in the information communicating terminal device by the maintenance company can be notified of to the user. Also, inquiry of the stock control host apparatus about stock confirmation, and ordering to the host apparatus are possible.

(4) The latest stock control information can always be acquired.

(5) If a disorder occurs in the information communicating terminal device, the progress of maintenance by the responsible maintenance person can be notified of to any contact person who has been designated beforehand.

(6) Disorder processing information on the information communicating terminal device can be supplied through the communications network. Also, the type of information acquirable by the access person is restricted to prevent unauthorized access.

Disclosed embodiment can be varied by a skilled person without departing from the spirit and scope of the invention.

What is claimed is:

1. An apparatus, coupled to an information-communicating terminal device and a stock control host apparatus through a communication network, for supporting a maintenance service operation in respect to said information-communicating terminal device, said apparatus comprising:
a disorder information receiving section to receive disorder information sent from said information-communicating terminal device when it enters in a certain disorder condition;
a disorder information table storing section to store a disorder information table in which said disorder information are correlated with parts information for restoring said disorder condition of said information-communicating terminal device;
a disorder information table reading section to readout said parts information, based on said disorder information while referring to said disorder information table; and
an ordering section to receive an ordering result sent from said stock control host apparatus.

2. The apparatus of claim 1, further comprising:
an identification information receiving section to receive identification information for identifying said information-communicating terminal device, which are transmitted therefrom;
a maintenance data storing section to store maintenance data in a maintenance database in which at least information of a personnel, in charge of a maintenance for said information-communicating terminal device, are correlated with said identification information;
a maintenance data reading section to readout at least said information of said personnel in charge of said maintenance for said information-communicating terminal device, based on said identification information while referring to said maintenance database; and
a parts information transmitting section to transmit at least a part of said parts information to a portable remote terminal possessed by said personnel, which is specified by referring to said information of said personnel in charge of said maintenance.

3. The apparatus of claim 2,
wherein, in said disorder information table, said disorder information are also correlated with a disorder content occurring in said information-communicating terminal device, and said disorder information table reading section readouts said disorder content, based on said disorder information while referring to said disorder information table; and
wherein, in said maintenance database, said identification information are also correlated with customer information of said information-communicating terminal device, and said maintenance data reading section readouts said customer information, based on said identification information while referring to said maintenance database; and further comprising:
a maintenance information transmitting section to transmit at least a part of said disorder content and said customer information to said portable remote terminal possessed by said personnel, which is specified by referring to said information of said personnel in charge of said maintenance.

4. The apparatus of claim 2, further comprising:
a disorder processing information receiving section to receive processing information, for restoring said disorder condition of said information-communicating terminal device, which are transmitted from said portable remote terminal possessed by said personnel in charge of said maintenance; and
an order information creating section to create parts-ordering information, based on said processing information for restoring said disorder condition of said information-communicating terminal device.

5. The apparatus of claim 1, further comprising:
a stock information receiving section to receive stock information of maintenance parts, which are transmitted from said stock control host apparatus; and
a display section to display said stock information.

6. The apparatus of claim 2,
wherein said apparatus is a host computer, and said information-communicating terminal device is a copier having an information-communicating function, and said portable remote terminal is a cellular phone possessed by said personnel being a serviceperson or a salesperson of a maintenance service site; and
wherein said host computer, said stock control host apparatus, said copier and said cellular phone are coupled each other through said communication network including Internet and/or telephone lines, so as to constitute a system for automatically communicating information for supporting maintenance activities of said copier between them.

7. An apparatus, coupled to an information-communicating terminal device and a stock control host apparatus through a communication network, for supporting a maintenance service operation in respect to said information-communicating terminal device, said apparatus comprising:
a disorder processing information receiving section to receive processing information, for restoring a disorder condition currently occurring in said information-communicating terminal device, which are transmitted from a portable remote terminal possessed by a personnel in charge of a maintenance for said information-communicating terminal device;
a progress-status information creating section to create progress-status information, based on said processing information for restoring said disorder condition;
a notifying address information memory section to store address information of a notifying destination in advance, to which said progress-status information are transmitted;
a specific progress-status information memory to store specific progress-status information in advance; and
a progress-status information transmitting section to transmit said progress-status information to said notifying destination, based on said address information stored in said notifying address information memory section, when said progress-status information coincide with said specific progress-status information stored in said specific progress-status information memory.

8. The apparatus of claim 7, further comprising:
a disorder information receiving section to receive disorder information sent from said information-communicating terminal device when it enters in said disorder condition;
a disorder information table storing section to store a disorder information table in which said disorder information are correlated with a disorder content occurring in said information-communicating terminal device;
a disorder information table reading section to readout said disorder content, based on said disorder information while referring to said disorder information table;
an identification information receiving section to receive identification information for identifying said information-communicating terminal device, which are transmitted therefrom;
a first maintenance data storing section to store first maintenance data in a first maintenance database in which at least information of a personnel, in charge of a maintenance for said information-communicating terminal device, are correlated with said identification information;
a first maintenance data reading section to readout at least said information of said personnel in charge of said maintenance for said information-communicating terminal device, based on said identification information while referring to said first maintenance database; and
a disorder content transmitting section to transmit at least a part of said disorder content to said portable remote terminal possessed by said personnel, which is specified by referring to said information of said personnel in charge of said maintenance.

9. The apparatus of claim 8, further comprising:
a second maintenance data storing section to store second maintenance data in a second maintenance database in which at least said information of said personnel, in charge of said maintenance for said information-communicating terminal device, and user information are correlated with said identification information;
a second maintenance data reading section to readout at least a part of said information of said personnel, in charge of said maintenance for said information-communicating terminal device, and at least a part of said user information, based on said identification information while referring to said second maintenance database;
a maintenance information transmitting section to transmit at least a part of said user information to said portable remote terminal possessed by said personnel, which is specified by referring to said information of said personnel in charge of said maintenance.

10. The apparatus of claim 8,
wherein said apparatus is a host computer, and said information-communicating terminal device is a copier having an information-communicating function, and said portable remote terminal is a cellular phone possessed by said personnel being a serviceperson or a salesperson of a maintenance service site; and
wherein said host computer, said stock control host apparatus, said copier and said cellular phone are coupled each other through said communication network including Internet and/or telephone lines, so as to constitute a system for automatically communicating information for supporting maintenance activities of said copier between them.

11. An apparatus, coupled to an information-communicating terminal device and a stock control host apparatus through a communication network, for supporting a maintenance service operation in respect to said information-communicating terminal device, said apparatus comprising:
a disorder processing information receiving section to receive processing information, for restoring a disorder condition currently occurring in said information-communicating terminal device, which are transmitted from a portable remote terminal possessed by a personnel in charge of a maintenance for said information-communicating terminal device;
a progress-status information creating section to create progress-status information, based on said processing information for restoring said disorder condition;
a progress-status information providing section to provide said progress-status information within said communication network;
an accessing-person identifying information acquiring section to acquire accessing-person identifying information for identifying an accessing-person who accesses to said progress-status information providing section; and
an information supply restricting section to restrict a supply of information to be provided for said accessing-person, based on said accessing-person identifying information.

12. The apparatus of claim 11,
wherein said information supply restricting section restricts said supply of information to be provided for said accessing-person, in regard to at least a part of said progress-status information.

13. The apparatus of claim 11,
a restricted content memory section to store restriction data in a restricted content database in which at least said accessing-person identifying information are correlated with restricted content of said supply of information to be provided for said accessing-person; and
a restriction data reading section to readout said restricted content of said supply of information to be provided by said progress-status information providing section, based on said accessing-person identifying information while referring to said restricted content database;
wherein said information supply restricting section restricts a supply of information to be provided by said progress-status information providing section, based on said restricted content.

14. The apparatus of claim 11,
wherein said apparatus is a host computer, and said information-communicating terminal device is a copier having an information-communicating function, and said portable remote terminal is a cellular phone possessed by said personnel being a serviceperson or a salesperson of a maintenance service site; and
wherein said host computer, said stock control host apparatus, said copier and said cellular phone are coupled each other through said communication network including Internet and/or telephone lines, so as to constitute a system for automatically communicating information for supporting maintenance activities of said copier between them.
